(19) United States
(12) Patent Application Publication
(10) Pub. No.: US 2012/0322037 A1
(43) Pub. Date: Dec. 20, 2012

(54) Anomaly Detection Educational Process

(76) Inventor: Adrienne Raglin, Burtonsville, MD (US)

(21) Appl. No.: 13/163,712

(22) Filed: Jun. 19, 2011

(51) Int. Cl. G09B 19/00

(52) U.S. Cl. 434/247

(57) ABSTRACT

A process for educating a user to detect a visual target and a target-related anomaly in a visual field is provided that includes the collection of an image of a visual field displaying the target and the target-related anomalies. An image key is generated with location of the target and the target-related anomalies. The image is transformed into multiple panels that vary between one another as to a visual concealment parameter. A student user is then shown the multiple panels on a computer, with the user designating inputs into the computer as to user perceived location of the target and the target-related anomalies for each of the panels. Through scoring of the user inputs against the image key, the user is educated as to how to improve acuity and detection for target and anomaly detection.

### GOVERNMENT INTEREST

The invention described herein may be manufactured, used, and licensed by or for the United States Government.

### FIELD OF THE INVENTION

The present invention in general relates to a training technique and in particular to an educational process for correlating anomaly detection in a user with target detection.

### BACKGROUND OF THE INVENTION

Applications of anomaly detection can be found in a variety of areas such as medicine, computer security, communications, and target detection. Applications such as target detection take advantage of the existence of anomalies as a technique to identify objects and areas that are important (Chandola, Banerjee, and Kumar, 2009). In general, anomalies are seen as data points whose individual attributes are not consistent with the attributes of their environment.

The detection of anomalies uses techniques that enable an individual to locate targets whose characteristics are distinct from their surroundings without a priori knowledge of target type or location. The objects that deviate from their backgrounds are then considered by the observer to be anomalous. Currently, there is a lack of an organized controlled educational process to teach a professional to locate and identify anomalies within images with targets for specific professional tasks; and instead currently society relies on mentoring and experience gained through “on-the-job” training which may cause misinterpretation of imagery or reduction in efficiency particularly for those new to the task.

Thus, there exists a need for training tools that provide an educational process to allow a professional to learn that image anomaly detection can be correlated with target detection. With a quantifiable metric of correlation between anomaly detection and target detection within an image, proficiency of a professional in image analysis, as well as other educational techniques, would result.

### SUMMARY OF THE INVENTION

A process for educating a user to detect a visual target and a target-related anomaly in a visual field is provided that includes the collection of an image of a visual field displaying the target and the target-related anomalies. The image can be grayscale, color, false color, or from different spectrums and constitutes a two-dimensional image, an anaglyph, or an animation, with images captured to show the perceived distance to the target alone or in combination with the target-related anomalies. An image key is generated with location of the target and the target-related anomalies. The image is then transformed into multiple panels that vary between one another as to a visual concealment parameter. Visual concealment parameters operative herein illustratively include texture, contrast, white noise addition, and environmental effect simulations such as haze, fog, rain, or the like. A student user is then shown the multiple panels on a computer, with the user designating inputs into the computer as to user perceived location of the target and the target-related anomalies for each of the panels. Through scoring of the user inputs against the image key, the user is educated as to how to improve acuity and detection for target and anomaly detection.

A kit is provided that includes software for performing the process steps from image key generation through scoring on a computer having a visual display and a user interface. The user interface allows the user to input perceived locations of the target and the target-related anomalies. Instructions for the use of the software for education of the user to detect the target and the target-related anomalies in the visual field of the panels are also provided.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings being presented are for illustrative purposes only and should not be construed as a limitation on the scope of the present invention. A better understanding of the present invention is provided with reference to the following detailed description when read in conjunction with the accompanying drawings wherein like reference characters refer to like parts throughout the several views and in which:

FIG. 1 are a schematic flowchart according to an inventive process;

FIG. 2A is a light environment concealment panel of an image containing a target denoted with a red X and an indicator for the target denoted with a blue X;

FIG. 2B is the same image as FIG. 2A as a moderate environment panel;

FIG. 2C is the same image as FIG. 2A as a heavy environment panel;

FIG. 2D is the same image as FIG. 2A with a red box indicating the pixel area in which the target is located, a blue box indicating the pixel area in which the indicator is located. If the x and the box corresponds then a user is credited with identifying the target and indicator for the target being denoted by numbered red and blue boxes, respectively;

FIG. 2E is the same image as FIG. 2A with a red box indicating the pixel area in which the target is located, a blue box indicating the pixel area in which the indicator is located. If the x and the box corresponds then a user is credited with identifying the target and indicator for the target being denoted by numbered red and blue boxes, respectively;

FIG. 2F is the same image as FIG. 2A with a red box indicating the pixel area in which the target is located, a blue box indicating the pixel area in which the indicator is located. If the x and the box corresponds then a user is credited with identifying the target and indicator for the target being denoted by numbered red and blue boxes, respectively;

FIG. 3A is a light texture and light contrast concealment panel of a second image containing a target denoted with a red X and an indicator for the target denoted with a blue X;

FIG. 3B is the same image as FIG. 3A as a moderate texture and moderate contrast panel;

FIG. 3C is the same image as FIG. 3A as a heavy texture and heavy contrast panel;

FIG. 3D is the same image as FIG. 3A with a red box indicating the pixel area in which the target is located, a blue box indicating the pixel area in which the indicator is located. If the x and the box corresponds then a user is credited with identifying the target and indicator for the target being denoted by numbered red and blue boxes, respectively;

FIG. 3E is the same image as FIG. 3A with a red box indicating the pixel area in which the target is located, a blue box indicating the pixel area in which the indicator is located. If the x and the box corresponds then a user is credited with identifying the target and indicator for the target being denoted by numbered red and blue boxes, respectively; and

FIG. 3F is the same image as FIG. 3A with a red box indicating the pixel area in which the target is located, a blue box indicating the pixel area in which the indicator is located. If the x and the box corresponds then a user is credited with identifying the target and indicator for the target being denoted by numbered red and blue boxes, respectively.

### DETAILED DESCRIPTION OF THE PREFERRED EMBODIMENTS

The present invention has utility as an educational system to train a user to become proficient at detecting targets within an image field based on associated indicators, synonymously referred to herein as anamolies, that a target is present in the visual field. A user through operation of the inventive educational system becomes proficient at anomaly detection in a controlled setting and demonstrates superior ability to detect targets within a visual field under operational conditions. Representative users that benefit from practicing anomaly detection according to the present invention, synonymously referred to herein as target detection, within a visual field illustratively include war fighters, radiologists, archeologists, resource exploration geologists, microscopists, criminologists, and quality control specialists. In operation, a user is presented with a series of digitally modified panels derived from an image with the modifications including change of contrast, texture, or visibility with successive incremental easing of detection of indicators and targets within the otherwise unchanged visual field. In a preferred embodiment, the imagery to which a user is exposed will begin with the most challenging visualization parameters with successive images providing greater ease of visualization. It is appreciated that visual image fields in the inventive educational process can include two-dimensional images, three-dimensional data sets, anaglyphs, and animations. It is appreciated that the image field can be grayscale, color, false color, or from different spectrums. It is further appreciated that the image field can be static as provided in the exemplary figures provided herewith or constitute a video providing a user a sense of motion relative to the visual field.

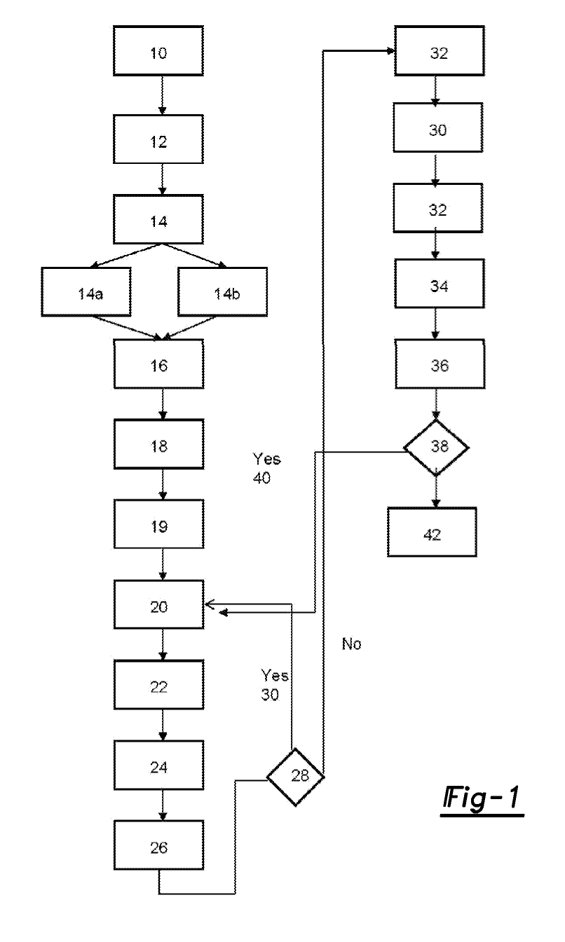

A process of preparing visual fields for user training is depicted schematically in FIG. 1. A high quality image is collected containing both an indicator and target within the imagery at 10. The image collected at 10 can be illustratively black and white, color, false color, or from different spectrums and are in the form of two-dimensional images, anaglyphs, or videos. These various forms of visual fields are all considered as images within the context of the present invention.

The imagery collected at step 10 is then marked to show actual indicators and targets to generate an image key at step 12. Such image marking is readily performed with conventional software illustratively including MATLAB®. The marking of images at step 12 builds a library of image keys in which the location for indicators and targets are selected by the developer for the appropriate portion of the imagery. The resultant image keys serve as a ground truth. The image keys are invoked and the software serves as an interface for introduction, assignment of user task identification and group number, as well as presenting the imagery for practice and test scenarios to the user. As will be detailed subsequently, the software allows the user to mark multiple locations for targets with a specific target designator and indicators with a specific indicator marking with the locations of each indicated by a user being numbered and stored within a computer for subsequent scoring and analysis. The software package will also allow for extraction of raw data entered by a user to be matched with the appropriate ground truth image keys to generate detection scores.

The imagery collected and marked in steps 10 and 12, respectively, is then transformed at step 14 to produce a series of panels that vary in at least one parameter of visual acuity such as texture, contrast, tone, other image feature, or a combination thereof at step 14a. As an alternative or in combination with parameter variation across a series of images produced at step 14a, a mask is applied at step 14b to produce a series of images that are computationally modified by a mathematical mask applied to the image to simulate visibility changes associated with instrumentation background noise or atmospheric effects such as haze, fog, or blowing sand. Regardless of the nature of transformations to generate a series of images through steps 14a, 14b, or a combination thereof, the series of panels are optionally edited to remove transformational artifacts at step 16 so as to produce a set of test images that vary in the degree of obscurement a user will experience in attempting to identify a target and an indicator therefor. The resultant series of varying obscurement images for a given visual field have associated therewith an image key and pixel area denoting each indicator and each target within the image visual field. It is appreciated that a given image may contain multiple indicators, as well as multiple targets.

A user enters software at step 18 operating on a computer and having a visual display and user interface for data entry including location of indicators and targets observed by the user in a given image panel at step 18. Preferably, the software provides step-by-step instructions for a user as to what will be observed, requested inputs, and analysis at step 19. It is appreciated that software supplied information is readily supplied upon entry of the software at step 18 as a complete package or interspersed between each successive step, or a combination thereof.

The user is then shown a specific visual panel at step 20. Preferably, the user is shown image panels regardless of whether modified by techniques of steps 14a, 14b, or a combination thereof with the most obscured panels being initially shown with decreasing degrees of obscurement in subsequent viewed panels. Optionally, the panel display is for a preselected period of time so as to train a user to more rapidly analyze panel imagery for detection of indicators and targets therein. A user is then prompted to designate location of all targets and indicators observed in a given image panel at step 22. Preferably, a different user interface supplied marking of an image panel is provided to differentiate between a target and an indicator. Optionally, with specific markings are made by the user on an overlay to the panel to denote correlations between specific pairings of indicators and targets within an image panel.

With user entry of markings to designate all targets and indicators observed in a given image panel, the software records a user perceived position of each target and indicator designated by the user at step 24. The software ascribes a score to the user recorded location of indicators and targets against the image key at step 26. The scoring is appreciated to be binary or graded as to proximity to an indicator or target center. In the event that additional image panels remain in a series of panels generated from a given image at step 28, then the user is exposed to an iterated image panel having a different degree of obscurement relative to that initially observed at step 30 and process steps 20-28 are repeated. Optionally, a user can opt-out of viewing the remainder of panels in an image series if they believe they have mastered the exercise. In the event that a user has completed the series of image panels at step 28, then the unit is noted as being completed at step 32. The software scores the user as to efficiency at indicator and target detection at step 34 and communicates such scoring at step 34 to either the user or an instructor for the user, or a combination thereof. Optionally, the user after completing a unit at step 32 is provided with an explanation of visual clues entered into the software by experts to make the user more perceptive as to clues as to the presence of an indicator or target regardless of the level of obscurement at step 36. Optionally, a user is prompted if they would like to view yet another unit composed of a series of image panels at step 38 if so, steps 20-36 are repeated, else the user may end the session at step 40.

The present invention is further detailed with respect to the following nonlimiting examples which are intended to provide greater detail as to specific embodiments of the present invention. These examples are not intended to limit the scope of the invention or the appended claims.

### EXAMPLE 1

### Development User Questionnaire

A potential user group was given a questionnaire inquiring as to which features and factors the users felt influenced target detection, particularly when things appeared to be anomalous or out of place. A list of such features that are related to images in general and environment factors is then selected. This initial data offered clues for a target component, the target itself, or indicators of the target. Different elements of visual field are identified through questionnaire as to image features that can result in perception of an anomaly in an image with such factors illustratively including shape, color, contrast, and texture. Environmental factors unique to the particular user group such as instrument noise, environmental factors, and backgrounds were also noted. Additionally, potential users were asked to describe any anomalies that were noted in a given image that were visual clues as to the presence of a target. Additionally, users were asked to describe techniques they felt most successful in target detection and the image quality factors that most influenced their ability to detect such targets.

### EXAMPLE 2

### Educational Procedure

Two independent stations are used; each station included one monitor and one mouse. Each user is asked to sit at a station approximately 24 inches from the monitor, which is marked by a strip of blue masking tape, also each user is asked not to lean beyond this area. They are informed that the task would be done through the inventive software and they would read the instructions for each scenario on the monitor before the individual scenarios started. The researcher started the software for each monitor. The users read the instructions and completed a practice scenario. The practice scenario is given to allow the user an opportunity to familiarize himself with the task, to practice finding the targets and indicators by using the mouse, and to ask any questions about any of the task procedures. After confirming that the user is willingly prepared to complete the task, the researcher asked for the test ID number of the user, entered it into the system, assigned a group number, and the remainder of the task is started. The researcher is present to answer any additional questions, to clarify any part of the task, and to monitor their activity. The task took approximately 20 minutes to complete.

### EXAMPLE 3

### Equipment and Image Development

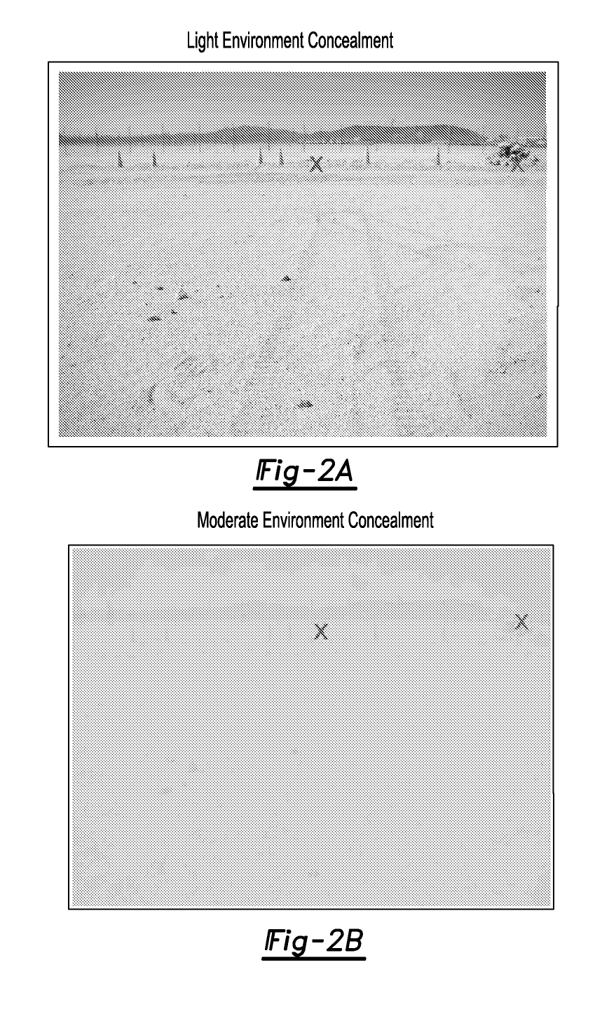

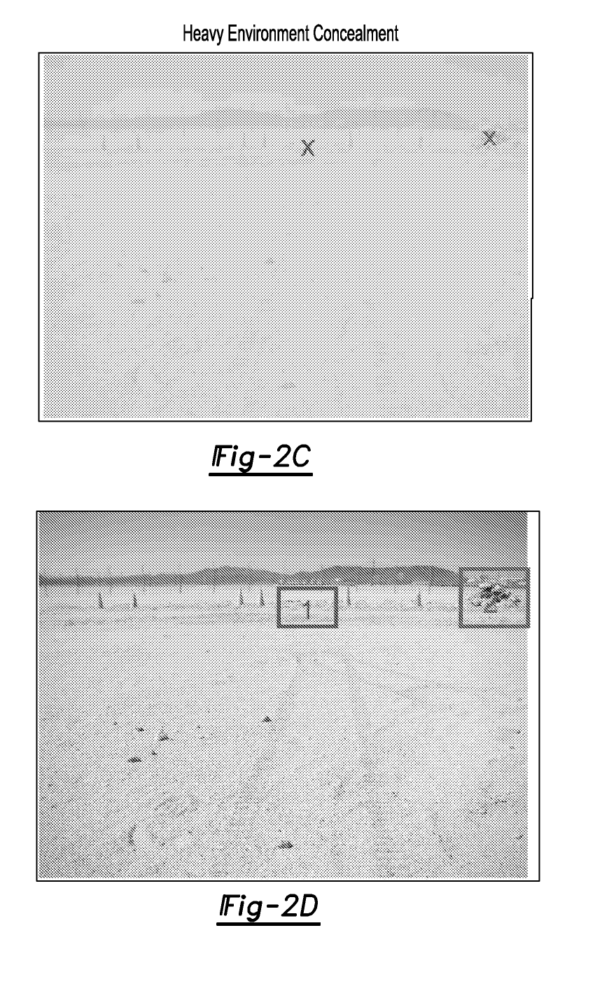

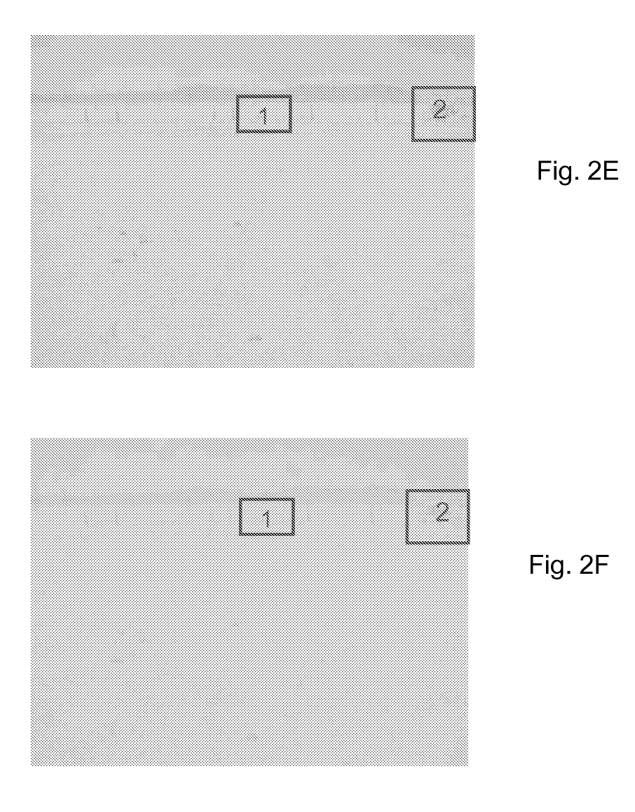

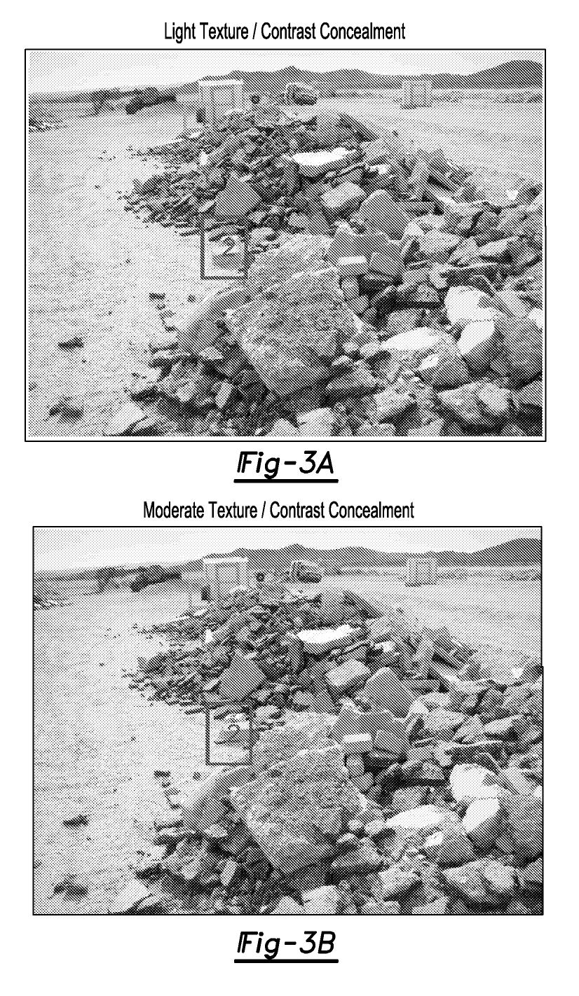

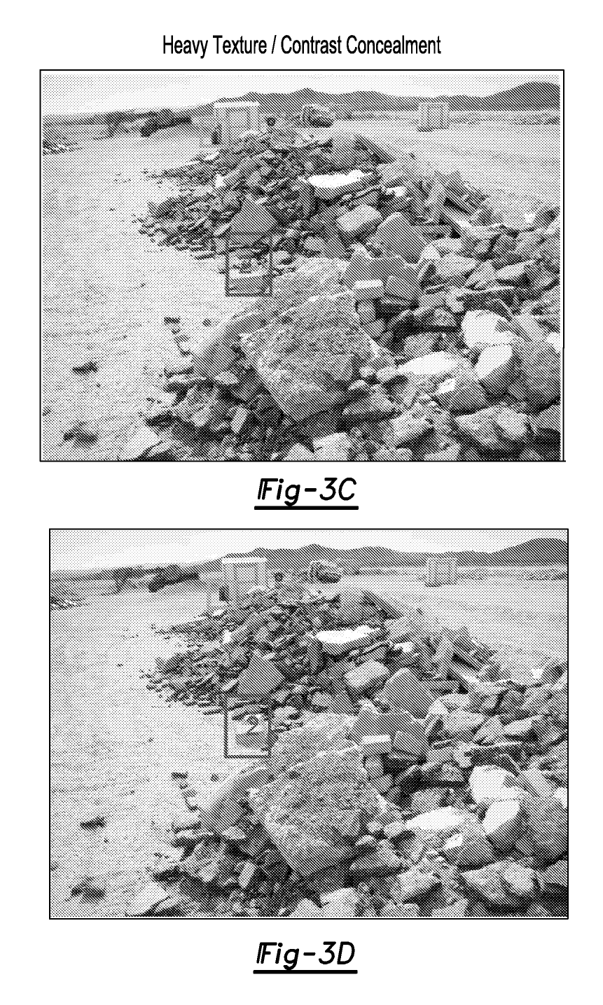

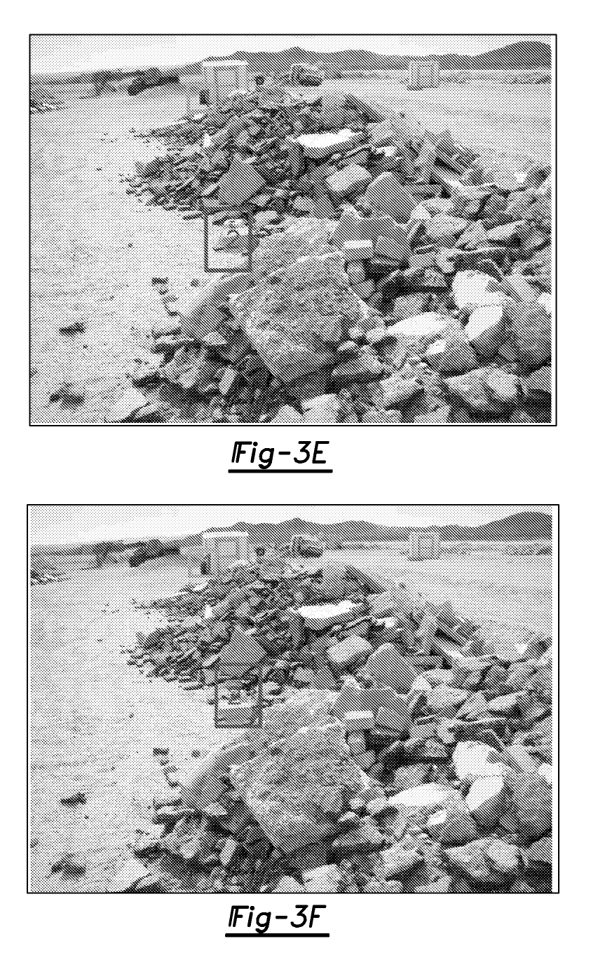

A software-based tool to present images of targets is developed for the Anomaly Detection Task. This allowed for a portable and adaptable tool. High-resolution 2D images of areas with targets are collected from appropriate sites. The images were captured with Sony DSC-HP cameras at full resolution of 8 megapixels. The raw images were 3264×2448 pixels in size. All images are captured on full auto mode for best average exposure at full wide field of view of approximately 40 degrees. The raw image from the camera is retrieved using the JPEG file type. An Apple 23-inch active-matrix LCD display is used to present the images for viewing. The display has 1920×1200 pixels resolution, 16:10 image aspect ratio, 400 cd/m² image brightness, and 700:1 image contrast ratio. A MacBook Pro is used to run the software as well as store and process the images. The MacBook Pro has 2.5 GHz Intel Core 2 Duo Processor with 2 GB memory. The images are collected at various incremental distances between 2 m and 25 m. A variety of targets are used. Representative image panels with graded texture/contrast concealment and environmental concealment are depicted in FIGS. 2A-2C and FIGS. 3A-3C, respectively, with targets (red X) and indicators (blue X) therefor marked.

From the responses to the questionnaire two features and two factors are selected to be used to digitally transform the imagery for a series of image panels. A subset of original images was selected and image transformation techniques are applied that generated new images with different levels. One set of images is modified by changing the texture and contrast. In these images multiple overlays are added to a region of interest. A second set of images was modified by applying a mask over the scene, simulating a change in visibility. These transformations are generated with the assistance of a graphic artist to limit any affects from artifacts to the image.

The contrast and texture overlays in Scenario 1 considered two fundamental visual cues. Contrast can be defined as the perceived relative brightness of objects within a scene, affecting an individual's ability to distinguish objects from the background. The human visual system is sensitive to a range of spatial frequencies. However, high and low spatial frequencies require higher contrast than mid frequencies. Texture can be defined as the spatial variations of intensities in a region of an image. These variations can be perceived as patterns that can be used in object recognition as well as segmentation.

The mask in Scenario 2 applied a low spatial frequency modification to the scene, increasing the low spatial frequency energy. The target inherently has a band-limited signature that is device specific as well as size and range dependent. In general the background is rich in low- and mid-range spatial frequencies. Ideally, the target signature can be isolated from the signature of the background disregarding artifacts due to the sensor specification, compression losses, and atmospheric effects.

The inventive process required the users to view three sets of images divided into three scenarios. The users are divided into three groups defined by one of three distance combinations. The distance combinations are given in Tables 1, 2, and 3. Each user viewed 28 images in Scenario 1, 26 images in Scenario 2, and 27 images in Scenario 3. Each image included at least one target. The users are asked to respond be using the mouse and with the left mouse click mark the location of the targets and with the right mouse click mark the location of other anomalous objects. To aid in this process the left and right mouse buttons are marked with a red and a blue dot respectively. If a user marked a potential target location by clicking the left mouse button, a red cross appeared on the screen and if a potential anomaly location is marked by clicking the right mouse button, a blue cross appeared on the screen. The x and y coordinates of the locations for the selected targets and objects with respect to the image were recorded. Each image appeared on the screen for 7 seconds. The total task took approximately 20 minutes.

### EXAMPLE 4

### User Educational Study

Initially 14 images are used for Scenarios 1 and 2 combined. Scenario 1 images level modification is based on changes in texture and contrast. Scenario 2 images level modification is based on changes in visibility by applying an atmospheric mask. Each modification is incrementally changed by 10% giving each image eleven levels. Each image is presented to the users for 10 s and using a mouse they are able to select any objects within the scene and mark them with a red cross for targets or a blue cross for any anomalous objects. In the instructions, the user is informed that the first images presented include targets that are at the hardest level, and then for each iteration of the images the level decreases.

### EXAMPLE 5

### Simultaneous Modifications

After the pilot studies were completed and evaluated, the original test design is modified to counterbalance image exposure and limit fatigue. The time the image is presented is reduced to 7 s. The number of levels for Scenarios 1 and 2 are reduced from ten to four. Scenario 1 levels included 70%, 40%, 20% and 0% levels. Scenario 2 levels included 80%, 60%, 40%, and 0% levels. These levels are derived from the pilot data. Seven images are used for Scenario 1 and six for Scenario 2 with FIGS. 2A-2C and FIGS. 3A-3C being representative subsets. In addition, Scenario 3 is added. In Scenario 3 the images are not post-processed to change levels but have targets at various distances. A total of 27 images are used in Scenario 3. Tables 1 through 3 show the experimental design for the presentation of the images.

TABLE 1
Distances of Images for Scenario 1
Scenario 1

| | Image 1 | Image 2 | Image 3 | Image 4 | Image 5 | Image 6 | Image 7 |
|---|---|---|---|---|---|---|---|
| Group 1_1 | 3 m | 25 m | 5 m | 25 m | 5 m | 3 m | 25 m |
| Group 1_2 | 25 m | 5 m | 3 m | 5 m | 2 m | 25 m | 5 m |
| Group 1_3 | 5 m | 3 m | 25 m | 2 m | 25 m | 5 m | 2 m |

TABLE 2
Distances of Images for Scenario 2
Scenario 2

| | Image 1 | Image 2 | Image 3 | Image 4 | Image 5 | Image 6 |
|---|---|---|---|---|---|---|
| Group 2_1 | 25 m | 3 m | 5 m | 25 m | 2 m | 5 m |
| Group 2_2 | 5 m | 25 m | 3 m | 5 m | 25 m | 2 m |
| Group 2_3 | 3 m | 5 m | 25 m | 3 m | 5 m | 25 m |

TABLE 3
Distances of Images for Scenario 3
Scenario 3

| Distances | Number of Images |
|---|---|
| Less than 10 m | 7 |
| Between 10 m and 15 m | 12 |
| Greater than 15 m | 8 |

For Scenarios 1 and 2 the highest scores were for users that found the most targets at the highest levels. A weighted score is calculated using the following equation

$$Weighted Score = \frac{1}{N} {\sum }_{l = 1}^{L} l * n ( l ) ,$$

where L represents the number of levels, n(1) represents the number of targets found at the corresponding level, and N represents the total number of images in the scenario. The weighted score ranges from 0.0 to 1.0. For Scenario 3 the highest scores would be given to the users that found the most targets. A score is calculated using the following equation

$$Score = \frac{1}{N} {\sum }_{l = 1}^{N} n ,$$

where N represents the total number of targets. The normalized score ranges from 0.0 to 1.0.

A kit is provided that includes software for performing steps 14-32 of FIGS. 1A and 1B on a computer. The computer has a visual display and a user interface for entry of user designating inputs into the computer as to user perceived location of a target and a target-related anomalies. The kit also includes instructions for the use of the software to perform various steps and thereby educate a user as to how to detect a visual target and at least one related visual anomaly in the visual field of a collected image as detailed herein.

The inventor contemplates a plurality of embodiments of the Anomaly Detection Tool invention including but not limited to those listed herein. For example, various embodiments contemplated include a stand-alone application version of the tool, a team network application that runs on multiple platforms, and a web based application. The inventor further contemplates implementing the tool and user interface portions of the invention with imagery such as that found in a virtual game environment. The inventor also contemplates the implementation of annotated answer keys and a dynamic system for drawing information (answers and questions) from various subject matter expert sources. The inventor further contemplates an automated annotation feature that provides users with warnings and tips to help scrutinize various and sundry physical areas of the graphic or picture more closely. Finally, the inventor contemplates integrating the tool and user interface into a camera system thereby allowing real time scanning and processing of images to detect anomalies and provide warnings in real time.

1. A process for educating a user to detect a target and at least one target-related anomal in a visual field, the process comprising:
(a) collecting an image of the visual field displaying the target and the at least one target-related anomaly;
(b) generating an image key locating the target and the at least one target-related anomaly;
(c) transforming said image into a plurality of panels varying in a visual concealment parameter;
(d) showing a user said plurality of panels on a computer;
(e) said user designating inputs to said computer of user perceived location of the target and the at least one target-related anomaly for each of said plurality of panels; and
(f) scoring said inputs against said image key to educate the user to detect the target and the at least one target-related anomaly in the visual field.

2. The process of claim 1 wherein said image is a color two-dimensional image.

3. The process of claim 1 wherein said image is in grayscale, false color, or from different spectrums.

4. The process of claim 1 wherein said image is an anaglyph or an animation.

5. The process of claim 1 further comprising collecting said image of the visual field to include a second target.

6. The process of claim 1 wherein the visual field is a battlefield scene, a medical image, a geologic scan, or a product quality control image.

7. The process of claim 1 wherein the generating step comprises spatially marking on said image and storing said image key in said computer.

8. The process of claim 1 wherein the visual concealment parameter is at least one of texture, contrast, white noise, environmental effect simulation, or a combination thereof.

9. The process of claim 1 wherein the visual concealment parameter is produced by applying a masking function to said image.

10. The process of claim 1 wherein said showing step occurs for a preselected amount of time.

11. The process of claim 1 wherein the showing step has the user seeing said plurality of panels sequentially from a highest level of application of the visual concealment parameter to a lowest level of application of the visual concealment parameter.

12. The process of claim 1 further comprising repeating the steps (b)-(f) with said image transformed by a second visual concealment parameter.

13. A kit comprising:
software for performing the steps (b)-(f) of claim 1 on a computer, said computer having a visual display and a user interface for entry of perceived location of said target and said at least one target-related anomaly; and instructions for the use of said software on said computer for educating the user to detect a visual target and the at least one target-related visual anomaly.
